(19) United States
(12) Patent Application Publication
(10) Pub. No.: US 2026/0348031 A1
(43) Pub. Date: Nov. 5, 2026

(54) A MEMBRANE ELECTRODE ASSEMBLY

(71) Applicant: Oort Energy Ltd., Whitchurch, Bristol (GB)

(72) Inventor: Nicholas Joseph Van Dijk, Rotherham, Yorkshire (GB)

(73) Assignee: Oort Energy Ltd., Whitchurch, Bristol (GB)

(21) Appl. No.: 19/108,056

(22) PCT Filed: Aug. 31, 2023
(86) PCT No.: PCT/GB2023/052264

§ 371 Date: Feb. 28, 2025

(30) Foreign Application Priority Data
Sep. 1, 2022 (GB) 2212734.4

(51) Int. Cl. C25B 11/091; C25B 1/04; C25B 13/08

(52) U.S. Cl. CPC C25B 11/091; C25B 1/04; C25B 13/08

(57) ABSTRACT

A membrane electrode assembly (MEA) for producing hydrogen in a water electrolyser is provided. The MEA comprises a polymer electrolyte membrane (REM), a cathode comprising a cathode catalyst on a first side of the REM, an anode comprising an anode catalyst on a second side of the REM, and a platinum-ruthenium (Pt—Ru) catalyst located on the second side of the REM for electrochemically converting hydrogen gas into hydrogen cations in use. The Pt—Ru catalyst is in electrical contact with the anode and ionic contact with the REM.

### FIELD OF THE INVENTION

This invention relates to a membrane electrode assembly (MEA) for a hydrogen electrolyser.

### BACKGROUND

As demand for renewable energy sources increases, there is a greater need to produce hydrogen in a safe and efficient manner. Hydrogen is commonly obtained from the electrolysis of water using a water electrolysis cell. This is an electrochemical device that dissociates water to produce hydrogen and oxygen gases. Most commonly used electrolysers incorporate a polymer electrode membrane (PEM). As shown in FIG. 1, a PEM water electrolysis cell includes a cathode, an anode and a polymeric electrolyte. The polymeric electrolyte is positioned between the cathode and the anode and transports ions between the electrodes while preventing the transport of electrons. In addition, catalysts are embedded in (or surrounded by) the polymeric electrolyte whilst being below a percolation threshold to ensure both electronic and ionic conductivity. This ensures the ions can get to and from the polymeric electrolyte.

During operation of a PEM water electrolysis cell, water is electrochemically oxidised to oxygen gas at the anode catalyst and hydrogen cations (protons) move through the polymeric electrolyte to the cathode catalyst where they are electrochemically reduced to hydrogen gas. The protons migrate from the anode to the cathode due to an applied electric field across the PEM. The rate of consumption of water, and thus, the rate of hydrogen and oxygen generation, is governed by Faraday's law in that an increase of the current passed through the cell will result in a corresponding increase in the generation of gas and consumption of water. PEM electrolysis is beneficial over other types of electrolysis because the hydrogen produced is of a high purity, the hydrogen can be produced under pressure and the efficiency is greater by comparison with other forms of electrolysis. However, the efficiency is limited by the resistance of the membrane, particularly at high current densities. The voltage losses (inefficiencies) are directly proportional to the resistance (voltage loss=current*resistance).

A problem associated with conventional PEM electrolysers is that hydrogen can diffuse across the membrane to the anode side and mix with oxygen to form a flammable or explosive mixture. This occurs particularly when the hydrogen is at pressure. This hydrogen diffusion problem is typically remedied by using a thick membrane (above 125 μm), preferably made of perfluorosulfonic acid (PSFA) polymers, such as Nafion® or Aquivion®, to effectively reduce the hydrogen diffusion through the membrane. However, the use of such thick membranes introduces a significant ohmic resistance and consequently a lower efficiency of the electrolyser, especially at current densities above 1 A·cm⁻².

Several known technologies have been employed to minimise the accumulation of hydrogen in the anode compartment.

For example, WO 2019/009732 discloses supplying humidified air to the anode (oxygen) compartment of the PEM electrolysis cell to dilute any diffused hydrogen and keep the atmosphere below the lower explosion limit (LEL) of hydrogen-air mixtures of about 4 mol %. This minimises the risk that flammable or explosive gas mixtures will be formed during operation of the electrolysis cell. Water is applied to the cathode (hydrogen) compartment and diffuses across the membrane to the anode catalyst where it is oxidised into protons, oxygen and electrons. However, a drawback of this process is that it is reliant on the diffusion of water across the membrane to the anode, which can limit the current density.

M Schalenbach, D Stolten “High pressure water electrolysis: Electrochemical mitigation of product gas crossover”, Electrochimica Acta, 156 (2015), pp 321-327, discloses embedding platinum in the PEM to prevent hydrogen diffusion. The platinum, which is not electrically connected to either electrode, acts as a recombination catalyst and converts hydrogen and oxygen gas in the membrane to water. However, this approach has its downsides. Since the platinum must be embedded in the membrane, the membrane must be specially cast around the catalyst. Commercially available membranes cannot be used. Therefore, the costs of manufacturing and maintaining an electrolyser having such an embedded catalyst are higher than those of conventional PEM electrolysers. In addition, as the hydrogen is under pressure and the oxygen is typically not, the oxygen and hydrogen gases do not diffuse at the same rate. If the oxygen diffusion rate falls below a threshold level with respect to the diffusion rate of the hydrogen, the quantity of hydrogen in the PEM can exceed the capacity of the recombination catalyst which may result in an accumulation of hydrogen in the anode compartment.

N. Briguglio, F. Pantò, S. Suracusano, and A. Aricò, “Enhanced performance of a PtCo recombination catalyst for reducing H₂ concentration in the O₂ stream of a PEM electrolysis cell in the presence of a thin membrane and a high differential pressure”, Electrochimica Acta 344 (2020) p 136153, also discloses the use of a recombination catalyst (based on a PtCo alloy) which is located in the anode compartment to recombine hydrogen and oxygen. A drawback of this system is that recombination does not work very well in wet conditions. Furthermore, Co has a tendency to leak out of the PtCo alloy, which limits the lifetime of the catalyst and can negatively affect operation of the electrolyser.

There is therefore a need for a PEM water electrolyser which alleviates the aforementioned problems, at least to some extent.

### SUMMARY OF THE INVENTION

In accordance with a first aspect of this invention, there is provided a membrane electrode assembly (MEA) for producing hydrogen in a water electrolyser, the MEA comprising:
a polymer electrolyte membrane (PEM),
a cathode comprising a cathode catalyst on a first side of the PEM,
an anode comprising an anode catalyst on a second side of the PEM, and
a platinum-ruthenium (Pt—Ru) catalyst located on the second side of the PEM for electrochemically converting hydrogen gas into hydrogen cations in use,
   wherein the Pt—Ru catalyst is in electrical contact with the anode and ionic contact with the PEM.

An advantage of the MEA is that it can prevent hydrogen from diffusing from the PEM to the second (anode) side, particularly during high-pressure electrolysis, and combining with oxygen to form a flammable or explosive mixture. Since the hydrogen is removed by the catalyst, the thick membranes used in conventional electrolysers to limit hydrogen diffusion are not required and a thinner membrane can be used which increases the efficiency of the electrolyser.

The MEA may be suitable for high pressure electrolysis, i.e. producing hydrogen in a water electrolyser at a pressure of at least 30 bar.

The combination of alloyed platinum and ruthenium in the catalyst provides an advantage over other hydrogen oxidation catalysts such as platinum because it does not oxidise at the potentials of operation of the electrolyser. When platinum is placed in contact with the anode catalyst (typically an Ir-based catalyst such as IrO₂), the potential of the hydrogen oxidation catalyst is high which could result in its oxidation to platinum oxide. Since metal oxides do not electrochemically reduce hydrogen, this would result in the deactivation of the catalyst. However, when Ru and Pt are alloyed, the Ru reacts with the Pt to keep the Pt in a neutral oxidation state and retain its electrochemical reactivity.

The PEM may have a thickness of 50 μm or less. For example, the PEM may have a thickness of less than 50 μm, from 10 μm to 50 μm, from 10 μm to 45 μm, from 10 μm to 40 μm, from 10 μm to 35 μm, or from 10 μm to 25 μm.

The MEA may further comprise an anode channel in fluid communication with the anode and configured to direct water to the anode and receive oxygen from the anode in use, and a cathode channel in fluid communication with the cathode and configured to receive hydrogen from the cathode in use, wherein the Pt—Ru catalyst may be located between the PEM and the anode channel and may be configured to reduce the quantity of hydrogen gas entering the anode channel from the PEM in use.

Oxygen is produced at the anode catalyst and conveyed from the PEM through the anode channel as a product of the electrolysis process. The Pt—Ru catalyst effectively forms a barrier that prevents hydrogen diffusing from the PEM into the anode channel and combining with oxygen to form a flammable mixture.

The Pt—Ru catalyst (i) may be dispersed in the anode, and/or (ii) may form a layer between the PEM and the anode.

Dispersing the Pt—Ru catalyst in the anode catalyst and/or forming a layer between the PEM and the anode catalyst, enables the Pt—Ru catalyst to effectively act as a barrier between the PEM and the anode channel. Furthermore, mixing or dispersing the Pt—Ru catalyst into the anode catalyst allows both catalysts to be applied to the PEM in a single step without disrupting existing MEA manufacturing processes.

The Pt—Ru catalyst may be present in an amount of 0.005 to 0.5 mg/cm², preferably 0.02 to 0.1 mg/cm². This equates to an amount of about 0.2 to 25 wt % of the anode catalyst loading, or about 1-5 wt % for the narrower range. An amount of Pt—Ru in these quantities is effective for preventing hydrogen from diffusing from the PEM into the anode channel.

The platinum may be present in the Pt—Ru catalyst in an amount of from 10 to 90 wt %, from 30 to 70 wt %, or about 50 wt %. Similarly, the ruthenium may be present in the Pt—Ru catalyst in an amount of from 90 to 10 wt %, from 70 to 30 wt %, or about 50 wt %.

Quantities of Pt and Ru within these ranges provide an optimised level of hydrogen oxidation activity while maintaining minimal levels of Pt oxidation and prolonged catalyst lifetimes.

In accordance with a second aspect of this invention, there is provided a method of manufacturing the MEA as defined above, the method comprising:
coating a first side of a polymer electrolyte membrane (PEM) with a cathode catalyst,
coating a second side of the PEM with an anode catalyst, and
applying a Pt—Ru catalyst to the second side of the PEM such that the Pt—Ru catalyst is in electrical contact with the anode catalyst and ionic contact with the PEM.

The method may further comprise securing an anode channel over the anode catalyst such that the anode channel is in fluid communication with the anode catalyst, securing a cathode channel over the cathode catalyst such that the cathode channel is in fluid communication with the cathode catalyst, and applying the Pt—Ru catalyst to the second side between the PEM and the anode channel.

The applying step may comprise:
(i) dispersing the Pt—Ru catalyst in a fluid anode catalyst to produce a mixture and coating the mixture on the PEM; and/or
(ii) forming a layer of the Pt—Ru catalyst on the PEM prior to coating the second side of the PEM with the anode catalyst.

The catalyst may be applied in an amount of 0.005 to 0.5 mg/cm², preferably 0.02 to 0.1 mg/cm².

The platinum may be present in the Pt—Ru catalyst in an amount of from 10 to 90 wt %, from 30 to 70 wt %, or 50 wt %. Similarly, the ruthenium may be present in the Pt—Ru catalyst in an amount of from 90 to 10 wt %, from 70 to 30 wt %, or 50 wt %.

The Pt—Ru catalyst of the MEA may consist essentially of platinum and ruthenium.

In accordance with a third aspect of this invention, there is provided a use of an MEA as defined above for producing hydrogen.

Advantages of the second and third aspects of the invention are similar to those described above in relation to the first aspect of the invention, as would be understood by the skilled person.

The present invention will be better understood in light of the following examples and the accompanying figures, which are given in an illustrative manner only and should not be interpreted in a restrictive manner.

### BRIEF DESCRIPTION OF THE FIGURES

In the accompanying Figures:

FIG. 1 is a sectional view of a prior art MEA for producing hydrogen in a water electrolyser in which the permeation of H₂ from the cathode side to the anode side of the MEA is shown.

FIG. 2 is a sectional view of a MEA for producing hydrogen in a water electrolyser according to the present invention in which H₂ is prevented from diffusing from the PEM into the anode channel by a Pt—Ru catalyst layer.

FIG. 3 is a schematic representation of the MEA of FIG. 2 showing the relative positions of the anode layer, Pt—Ru catalyst layer, PEM and cathode layer.

FIG. 4 is a graph illustrating the enhanced efficiency of an electrolyser comprising an MEA according to the present invention over an electrolyser comprising a prior art MEA.

FIG. 5 is a cell IV curve showing current density (A cm⁻²) vs. cell voltage (V) using (i) a standard Nafion® N115 perfluorosulfonic acid (PFSA) membrane having a thickness of 127 μm, and (ii) a membrane containing a Ru—Pt catalyst layer according to the present disclosure.

FIG. 6 is a graph showing hydrogen permeation through (i) a standard Nafion® N115 perfluorosulfonic acid (PFSA) membrane having a thickness of 127 μm, and (ii) a membrane containing a Ru—Pt catalyst layer according to the present disclosure, at hydrogen differential pressures of 10 bar, 20 bar and 30 bar.

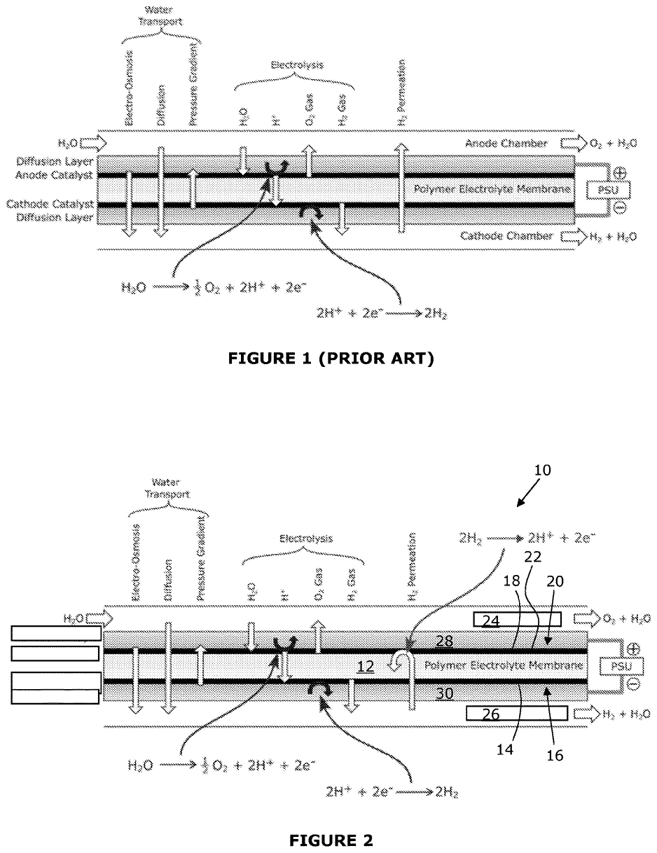

### DETAILED DESCRIPTION

As used herein and in the accompanying claims, unless the context requires otherwise, “comprise” or variations such as “comprises” or “comprising” will be understood to imply the inclusion of a stated integer or group of integers but not the exclusion of any other integer or group of integers.

As used herein, the term “about” in relation to the amounts expressed in weight percent means that the stated amount can vary by ±10% of the stated amount. For example, about 90 wt % means 90±9 wt %, and about 0.1 wt % means 0.1±0.01 wt %. When used with reference to a range, the term “about” applies to all values in the range.

As used herein, the term “consist(s) essentially of”, with respect to the components of a composition, alloy or mixture, means the composition, alloy or mixture contains the indicated components in a specified ratio and may contain minor additional components in an amount less than 1 wt % based on the total weight of the composition, alloy or mixture, and provided that the additional components do not substantially alter the reactivity of the composition, alloy or mixture.

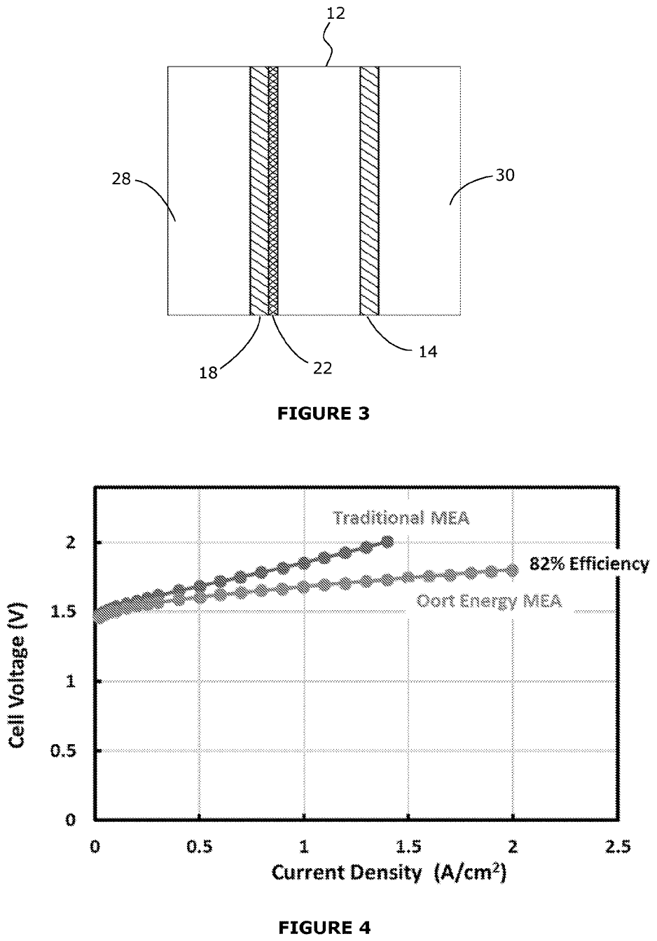

The present disclosure provides, in a first aspect, a membrane electrode assembly (MEA) for producing hydrogen in a water electrolyser (electrochemical hydrogen generator), particularly at high pressure. High pressure electrolysis is typically performed at pressures greater than about 30 bar, such as from 30 bar to 200 bar, from 50 bar to 200 bar, from 75 bar to 200 bar, or even greater than 200 bar). As shown in the embodiment represented in FIGS. 2 and 3, the MEA (10) comprises a polymer electrolyte membrane (PEM) (12), a cathode (14) comprising a cathode catalyst (also referred to as a hydrogen evolution catalyst) on a first side (16) of the PEM (12), an anode (18) comprising an anode catalyst (also referred to as an oxygen evolution catalyst) on a second side (20) of the PEM (12), and a platinum-ruthenium (Pt—Ru) catalyst (22) (also referred to as a hydrogen oxidation catalyst) located on the second side (20) of the PEM (12). The Pt—Ru catalyst (22) is suitable for electrochemically converting hydrogen gas into hydrogen cations when the MEA (10) is in use. The Pt—Ru catalyst (22) is in electrical contact with the anode (18), through which it operatively receives electrical energy for the electrochemical reaction. The Pt—Ru catalyst (22) is in ionic contact with the PEM (12) to permit hydrogen cations produced in the reaction to migrate to the cathode (14) where they may be converted to hydrogen gas.

The Pt—Ru catalyst (22) provides a barrier that prevents hydrogen from exiting the PEM (12) on the second (anode) side (20). This is particularly important when hydrogen is generated at the first (cathode) side (16) at elevated pressure, because the elevated pressure may increase the rate at which hydrogen diffuses through the membrane towards the anode side (20). By preventing hydrogen from permeating across the membrane during high pressure electrolysis, thinner PEMs can be used without the risk of hydrogen mixing with oxygen in the anode compartment and creating a flammable or explosive mixture. The ability to use thinner membranes in a high-pressure electrolysis process is desirable because it improves efficiency.

The MEA (10) may further include an anode channel (24) in fluid communication with the anode (18) on the second side (20) of the PEM (12). The anode channel (24) may be configured to direct water for the electrolysis reaction to the anode (18) and to receive oxygen produced during electrolysis of water from the anode (18). In this way, the anode channel (24) may serve as a conduit through which water (liquid and/or vapour) and oxygen is conveyed to and from the anode (18) catalyst surface. Similarly, the MEA (10) may further include a cathode channel (26) in fluid communication with the cathode (14) on the first side (16) of the PEM (12). The cathode channel (26) may be configured to receive hydrogen produced at the cathode (14) in use by the electrolysis of water and convey the hydrogen to a vessel for storage. The Pt—Ru alloy catalyst (22) may be located between the PEM (12) and the anode channel (24) on the second side (20) and may be configured to reduce the quantity of hydrogen gas entering the anode channel (24) from the PEM (12) in use.

The Pt—Ru catalyst (22) may be dispersed in the anode (18) and/or may form a layer between the PEM (12) and the anode (18). In a preferred embodiment, the Pt—Ru catalyst (22) may simply be dispersed in a solution or slurry of the anode (18) catalyst, and the dispersion applied to a PEM (12) in any number of conventional means known in the art (e.g. spraying, printing etc.). In another embodiment, the Pt—Ru catalyst (22) may be coated on the anode side (20) of the PEM (12) before the anode (18) catalyst is applied to the membrane (12). Alternatively, the Pt—Ru catalyst (22) may be applied to a completed (3 layer) MEA on top of the anode catalyst. The only pre-requisite is that the Pt—Ru catalyst (22) is in electrical and ionic contact with the anode catalyst and PEM, respectively. The MEA may further comprise an anode diffusion layer (28) (also referred to as an anode porous transport layer) between the anode (18) and anode channel (24), and a cathode diffusion layer (30) (also referred to as a cathode porous transport layer) between the cathode (14) and cathode channel (26).

The Pt—Ru catalyst (22) may be present in the MEA (10) in an amount of about 0.001 to 1 mg/cm², about 0.005 to 0.5 mg/cm², about 0.01 to 0.3 mg/cm² or about 0.02 to 0.1 mg/cm². This may equate to an amount of about 0.05 to 50 wt %, about 0.25 to 25 wt %, about 0.5 to 15 wt %, or about 1 to 5 wt % of the anode catalyst loading, respectively.

The platinum may be present in the Pt—Ru catalyst (22) in an amount of from about 10 to 90 wt %, from about 20 to 80 wt %, from about 30 to 70 wt %, from about 40 to 60 wt %, or about 50 wt %. Similarly, the ruthenium may be present in the Pt—Ru catalyst in an amount of from about 90 to 10 wt %, from about 80 to 20 wt %, from about 70 to 30 wt %, from 60 to 40 wt %, or about 50 wt %. Preferably the Pt and R^{u} are present in the Pt—Ru catalyst in an amount of about 50 wt % each. The Pt—Ru alloy catalyst (22) may consist essentially of platinum and ruthenium.

As shown in FIG. 4, water electrolysers of the prior art having a PEM with a thickness above 125 μm are operated with a stack efficiency of about 65-70% (higher heating value HHV). An electrolyser incorporating the MEA of the present invention can be operated at an efficiency of about 82% at high current densities and high pressure using a membrane with a thickness of about 50 μm without accumulation of hydrogen in the anode channel. This improvement in efficiency can be increased even higher if thinner membranes are used. For example, the MEA of the present disclosure may include a membrane having a thickness of 50 μm or less, 45 μm or less, 40 μm or less, 35 μm or less, 30 μm or less, or 25 μm or less. The membrane may have a thickness of from 10 μm to 75 μm, from 10 μm to 50 μm, from 10 μm to 45 μm, from 10 μm to 40 μm, from 10 μm to 35 μm, or from 10 μm to 25 μm.

The present disclosure provides, in a second aspect, a method of manufacturing the MEA described above. The method comprises coating a first side of a polymer electrolyte membrane (PEM) with a cathode catalyst to form a cathode, coating a second side of the PEM with an anode catalyst to form an anode, and applying a Pt—Ru catalyst to the second side of the PEM such that the Pt—Ru catalyst is in electrical contact with the anode catalyst and ionic contact with the PEM.

The method may further comprise securing an anode channel over the anode catalyst such that the anode channel is in fluid communication with the anode catalyst, securing a cathode channel over the cathode catalyst such that the cathode channel is in fluid communication with the cathode catalyst, and applying the Pt—Ru catalyst to the second side between the PEM and the anode channel. The anode channel and cathode channels may be secured by conventional means known in the art. As described above, the Pt—Ru catalyst may be applied to the second side of the PEM by dispersing the Pt—Ru catalyst in a fluid anode catalyst (e.g. a solution or slurry of the anode catalyst) to produce a mixture, and then coating the mixture on the PEM. Alternatively, or in addition, the Pt—Ru catalyst may be applied to the PEM prior to coating the second side of the PEM with the anode catalyst so that the Pt—Ru catalyst forms a layer between the PEM and the anode catalyst. The Pt—Ru catalyst may be applied to the PEM using conventional methods, such as spraying or printing. Whichever method is used, however, must result in the Pt—Ru catalyst being in electrical contact with the anode and ionic contact with the PEM.

The catalyst may be applied to the PEM in an amount as defined above in respect of the MEA.

The platinum and ruthenium may be present in the Pt—Ru catalyst in an amount as defined above in respect of the MEA.

The present disclosure provides, in a third aspect, use of an MEA as defined above for producing hydrogen. The use may typically involve providing a water electrolyser incorporating the MEA, applying electrical energy to the electrolyser, providing water to the electrolyser, and collecting hydrogen produced at the cathode side of the electrolyser. Oxygen produced at the anode side may be vented or collected. The hydrogen may be collected in a storage vessel for later use.

The invention will now be described in further detail with reference to the following non-limiting examples.

### EXAMPLES

### Example 1

0.25 mg of platinum black was place on a 0.5 mm diameter glassy carbon electrode, from a water/IPA solution containing a 1:4 ratio of ionomer (dispersed Nafion®) to catalyst. The electrode was rotated using a standard rotating disk apparatus at 1600 rpm and the potential scanned from −0.05V to 1.4V (vs SHE) at 0.01 V/s whilst hydrogen was bubbled over the electrode surface. The current initially rose to 2.3 A/cm². This current remained steady until the voltage reached 0.97V when it started to fall to zero.

Explanation: Platinum oxidises hydrogen, but the formation of platinum oxide inhibits the oxidation of platinum.

### Example 2

0.25 mg of a 1:1 ratio of platinum/ruthenium black was place on a 0.5 mm diameter glassy carbon electrode, from a water/IPA solution containing a 1:4 ratio of ionomer (dispersed Nafion®) to catalyst. The electrode was rotated using a standard rotating disk apparatus at 1600 rpm and the potential scanned from −0.05V to 1.4V (vs SHE) at 0.01 V/s whilst hydrogen was bubbled over the electrode surface.

The current initially rose to 1.4 A/cm². This current remained steady until the voltage reached 0.95V when it started to fall slightly to 0.7 A/cm². The fall was due to some oxidation of the unalloyed Pt/Ru but the remainder continued to oxidise the hydrogen.

### Example 3

An MEA was made by spraying a suspension of Pt/C and ionomer (1:1 carbon to ionomer) on one side of the membrane. On the other side, a thin layer of a 1:1 ratio of platinum/ruthenium black (in a suspension containing a 1:4 ratio of ionomer to catalyst). On top of the thin layer, a further layer of iridium oxide (in a suspension containing a 1:4 ratio of ionomer to catalyst) was sprayed onto the membrane. This membrane electrode assembly (MEA) was hot-pressed at 140 °C for 1 minute. The MEA was then put into an electrolyser cell and current passed until a pressure difference of 5 bar was built up across the membrane. The current was continued, and oxygen stream was monitored for hydrogen using a calibrated Hyoptima 720B inline hydrogen process analyzer connected to a DVM. The experiment was run for over 1 hour and no hydrogen was measured in the oxygen stream (above the level of detection of the instrument).

### Example 4

An MEA was prepared according to Example 3 but without the platinum ruthenium layer. The MEA was placed into the same electrolyser cell as Example 3 and the same conditions were repeated. After 1 hour, the Hyoptima 720B inline hydrogen process analyzer showed the presence of 0.7% hydrogen in oxygen.

### Example 5

Comparison of cell voltage and current density across an MEA prepared according to the present invention (Oort catalyst coated membrane) and an MEA containing a Nafion® N115 perfluorosulfonic acid (PFSA) membrane having a thickness of 127 μm. The MEAs were prepared as follows.

Catalyst ink was made by mixing a suspension of Nafion® ionomer, catalyst, and solvent (IPA/water mix), and dispersed in a low intensity ball mill. The catalyst was sprayed onto Nafion® 212 (50 μm thick), using a commercial ultrasonic sprayer on a heated vacuum plate. The loading of the cathode catalyst was 0.4 mg/cm² of platinum. The loading of the platinum-ruthenium catalyst was 0.2 mg/cm², and the loading of the iridium oxide anode catalyst was 2.0 mg/cm². For the control sample the same loading of iridium oxide anode catalyst and platinum cathode catalyst was used. The same inks were used but these were sprayed onto Nafion® 115 (125 μm thick).

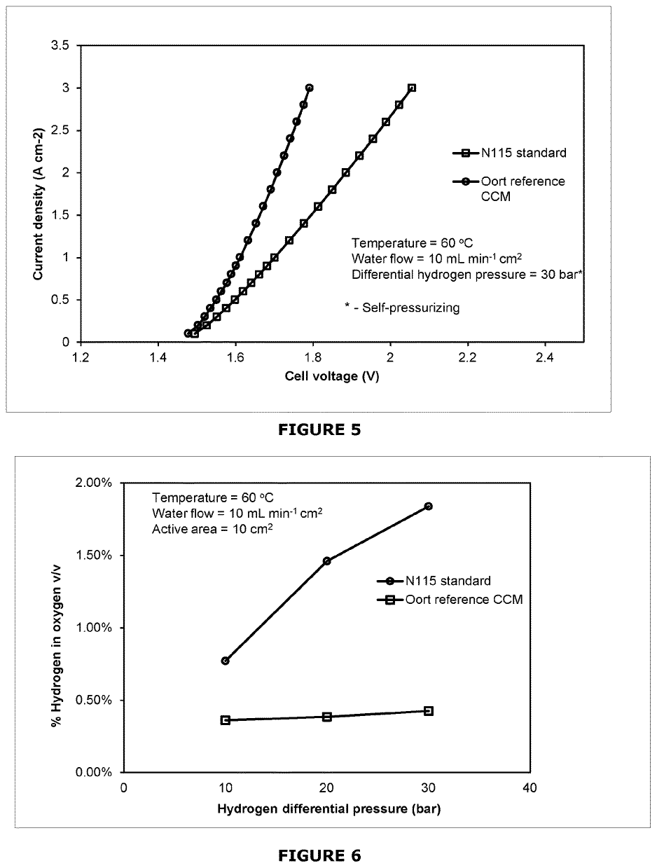

The MEA was placed in a high-pressure electrochemical cell (active area 10 cm²) and pressure was applied to the catalyst layer to ensure good contact (10 bar above operating pressure). Water, heated to 60 °C was pumped around the oxygen cavity at a flow rate of 100 ml/min. The maximum current was applied for 1 hour to ensure stability, then the voltage was recorded. The current was lowered and held constant for 1 minute. After 1 minute the voltage was recorded. The process was repeated to take the voltage at all current densities. The results are provided in Table 1 below and illustrated in FIG. 5.

TABLE 1

| Oort catalyst coated | |
|---|---|
| membrane (CCM) | |
| (according to the present | |
| disclosure) | N115 membrane |

| Current | | Current | |
|---|---|---|---|
| density (A | | density (A | |
| cm⁻²) | Voltage (V) | cm⁻²) | Voltage (V) |
| 0.1 | 1.4775 | 0.1 | 1.49474 |
| 0.2 | 1.5029 | 0.2 | 1.52566 |
| 0.3 | 1.5203 | 0.3 | 1.5515 |
| 0.4 | 1.5351 | 0.4 | 1.57543 |
| 0.5 | 1.5505 | 0.5 | 1.59832 |
| 0.6 | 1.5628 | 0.6 | 1.61922 |
| 0.7 | 1.5773 | 0.7 | 1.64016 |
| 0.8 | 1.5889 | 0.8 | 1.66104 |
| 0.9 | 1.6007 | 0.9 | 1.68095 |
| 1 | 1.6117 | 1 | 1.70088 |
| 1.2 | 1.6324 | 1.2 | 1.73865 |
| 1.4 | 1.6528 | 1.4 | 1.77649 |
| 1.6 | 1.6717 | 1.6 | 1.81338 |
| 1.8 | 1.6909 | 1.8 | 1.84923 |
| 2 | 1.708 | 2 | 1.88512 |
| 2.2 | 1.7258 | 2.2 | 1.92007 |
| 2.4 | 1.7419 | 2.4 | 1.95491 |
| 2.6 | 1.7582 | 2.6 | 1.98887 |
| 2.8 | 1.7761 | 2.8 | 2.02273 |
| 3 | 1.7909 | 3 | 2.05566 |

### Example 6

Hydrogen concentration measurements were taken in the anode compartment of the MEA of Example 5 at three different hydrogen differential pressures (10 bar, 20 bar and 30 bar) to determine the degree of hydrogen permeation across the membrane.

The MEA was placed in a high-pressure electrochemical cell (active area 10 cm²) and pressure was applied to the catalyst layer to ensure good contact (10 bar above operating pressure). Water, heated to 60 °C was pumped around the oxygen cavity at a flow rate of 100 ml/min. For the crossover measurements, the cell was run at 1 amp·cm² for 40 minutes to ensure equilibrium. A calibrated Hyoptima 720B (level of detection (“L.o.D”) is around 0.4%) was placed in the oxygen waster separation tank and the device connected to a calibrated digital voltmeter to display the amount of hydrogen in oxygen.

The results are provided in Table 2 below and illustrated in FIG. 6.

TABLE 2

| | | N115 | |
|---|---|---|---|
| | | membrane | |
| Oort CCM (according to | | H₂ | |
| the present disclosure) | | differential | |
| H₂ differential pressure | | pressure | |
| (bar) | % H₂ in O₂ | (bar) | % H₂ in O₂ |
| 10 | 0.36% | 10 | 0.77% |
| 20 | 0.38% | 20 | 1.46% |
| 30 | 0.43% | 30 | 1.84% |

1. A membrane electrode assembly (MEA) for producing hydrogen in a water electrolyser, the MEA comprising:
a polymer electrolyte membrane (PEM),
a cathode comprising a cathode catalyst on a first side of the PEM,
an anode comprising an anode catalyst on a second side of the PEM, and
a platinum-ruthenium (Pt—Ru) catalyst located on the second side of the PEM for electrochemically converting hydrogen gas into hydrogen cations in use,
wherein the Pt—Ru catalyst is in electrical contact with the anode and ionic contact with the PEM.

2. The MEA as claimed in claim 1 further comprising:
an anode channel in fluid communication with the anode and configured to direct water to the anode and receive oxygen from the anode in use; and
a cathode channel in fluid communication with the cathode and configured to receive hydrogen from the cathode in use; wherein the Pt—Ru alloy catalyst is located between the PEM and the anode channel and is configured to reduce the quantity of hydrogen gas entering the anode channel from the PEM in use.

3. The MEA of claim 1, wherein the MEA is suitable for producing hydrogen in a water electrolyser at a pressure of at least 30 bar.

4. The MEA of claim 1, wherein the PEM has a thickness of 50 μm or less.

5. The MEA of claim 1, wherein the Pt—Ru catalyst:
(i) is dispersed in the anode; and/or
(ii) forms a layer between the PEM and the anode.

6. The MEA of claim 1, wherein the Pt—Ru catalyst is present in an amount of 0.005 to 0.5 mg/cm², preferably 0.02 to 0.1 mg/cm².

7. The MEA of claim 1, wherein the platinum is present in the Pt—Ru catalyst in an amount of from 10 to 90 wt %, from 30 to 70 wt %, or 50 wt %.

8. The MEA of claim 1, wherein the ruthenium is present in the Pt—Ru catalyst in an amount of from 90 to 10 wt %, from 70 to 30 wt %, or 50 wt %.

9. A method of manufacturing the MEA of claim 1, the method comprising:
coating a first side of a polymer electrolyte membrane (PEM) with a cathode catalyst,
coating a second side of the PEM with an anode catalyst, and
applying a Pt—Ru catalyst to the second side of the PEM such that the Pt—Ru catalyst is in electrical contact with the anode catalyst and ionic contact with the PEM.

10. The method of claim 9 further comprising:
securing an anode channel over the anode catalyst such that the anode channel is in fluid communication with the anode catalyst,
securing a cathode channel over the cathode catalyst such that the cathode channel is in fluid communication with the cathode catalyst, and
applying the Pt—Ru catalyst to the second side between the PEM and the anode channel.

11. The method of claim 9, wherein the applying step comprises:
(i) dispersing the Pt—Ru catalyst in a fluid anode catalyst to produce a mixture and coating the mixture on the PEM; and/or
(ii) forming a layer of the Pt—Ru catalyst on the PEM prior to coating the second side of the PEM with the anode catalyst.

12. The method of claim 9, wherein the catalyst is applied in an amount of 0.005 to 0.5 mg/cm², preferably 0.02 to 0.1 mg/cm².

13. The method of claim 9, wherein the platinum is present in the Pt—Ru catalyst in an amount of from 10 to 90 wt %, from 30 to 70 wt %, or 50 wt %.

14. The method of claim 9, wherein the ruthenium is present in the Pt—Ru catalyst in an amount of from 90 to 10 wt %, from 70 to 30 wt %, or 50 wt %.

15. Use of an MEA as claimed claim 1 for producing hydrogen.
